(19) United States
(12) Patent Application Publication
(10) Pub. No.: US 2025/0164868 A1
(43) Pub. Date: May 22, 2025

(54) LIGHT SOURCE CURRENT ADJUSTMENT DEVICE AND METHOD FOR PROJECTION DEVICE

(71) Applicant: Coretronic Projection (Kunshan) Corporation, Jiangsu (CN)

(72) Inventor: Shen Peng, Jiangsu (CN)

(73) Assignee: Coretronic Projection (Kunshan) Corporation, Jiangsu (CN)

(21) Appl. No.: 18/896,924

(22) Filed: Sep. 26, 2024

(30) Foreign Application Priority Data
Nov. 17, 2023 (CN) 202311540872.2

(51) Int. Cl. G03B 21/20

(52) U.S. Cl. CPC G03B 21/2053

(57) ABSTRACT

Disclosed are a light source current adjustment device and method for a projection device. The light source driving circuit generates a driving current based on the direct current. The current monitoring circuit monitors the driving current to output a monitoring signal. The control circuit receives the monitoring signal from the current monitoring circuit, and controls the light source driving circuit to adjust the driving current according to the monitoring signal. The current monitoring circuit provides an adjusted driving current from the light source driving circuit to the light source.

### CROSS-REFERENCE TO RELATED APPLICATION

This application claims the priority benefit of China application serial no. 202311540872.2 filed on Nov. 17, 2023. The entirety of the above-mentioned patent application is hereby incorporated by reference herein and made a part of this specification.

### BACKGROUND

### Technical Field

The present disclosure relates to a display device, and in particular, to a light source current adjustment device and method for a projection device.

### Description of Related Art

Generally speaking, a projector using a laser diode (LD) as a light source is designed with the driving current set in a safe range in order to protect the projector's laser light source. For example, during the manufacturing process, after the circuit board of a projector is subjected to SMT (Surface Mount Technology), it is necessary to correct the driving current of the LD light source first to ensure that the driving current does not exceed the maximum working current of the LD light source before the projector is ready for a standby mode and can be turned on normally. However, even if the driving current of the LD light source is corrected before the projector leaves the factory, after the projector is used for a period of time, as the components age, the driving current output by the LD driver chip might also decrease, and therefore the LD light source will not be able to be driven with a proper driving current; consequently, the display quality will be degraded. Since the correction accuracy of the driving current depends on the accuracy of the detection of current, how to accurately obtain the driving current value flowing through the LD light source is a very important issue.

As shown in FIG. 1, in the related art, when the LD driver chip 102 provides the driving current ILD to the LD light source 104, the LD driver chip 102 may generate a sensing voltage VIMON through the sensing performed by the current sensing circuit 106 inside the LD driver chip 102 and the voltage on the resistor RCS connected to the LD light source 104 in series. The sensing voltage VIMON may, for example, be provided to a microprocessor inside the projector to calculate the value of the driving current ILD flowing through the LD light source 104. Such method of obtaining the driving current ILD is limited by the error of the resistor RCS itself and affected by the temperature coefficient of the resistor and other factors and therefore is likely to result in low accuracy. In addition, the current sensing circuit 106 detects the driving current ILD by measuring the voltage on the resistor RCS. The current sensing circuit 106 itself is not disposed on the current path of the driving current ILD, so the accuracy will be further reduced.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present disclosure provides a light source current adjustment device and method for a projection device, which may accurately monitor the driving current of the light source of the projection device, and may accurately correct the driving current of the driving light source based on the monitoring results to avoid decline of image display quality of the projection device.

Other objects and advantages of the present disclosure may be further understood from the technical features disclosed in the present disclosure.

In order to achieve one, part or all of the above purposes or other purposes, the light source current adjustment device of the projection device of the present disclosure is coupled to the light source of the projection device. The light source current adjustment device includes a light source driving circuit, a current monitoring circuit and a control circuit. The light source driving circuit generates a driving current based on the direct current. The current monitoring circuit is coupled between the light source driving circuit and the light source to monitor the driving current and output a monitoring signal. The control circuit is coupled to the light source driving circuit and the current monitoring circuit, receives the monitoring signal from the current monitoring circuit, and controls the light source driving circuit to adjust the driving current according to the monitoring signal. The current monitoring circuit provides an adjusted driving current from the light source driving circuit to the light source.

The present disclosure further provides a light source current adjustment method for a projection device, which includes the following steps. A current monitoring circuit is provided to monitor the driving current generated by the light source driving circuit based on the direct current to output a monitoring signal, wherein the driving current is configured to drive the light source of the projection device. The light source driving circuit is controlled to adjust the driving current according to the monitoring signal, and the current monitoring circuit provides an adjusted driving current from the light source driving circuit to the light source.

Based on the above, the current monitoring circuit of the present disclosure is coupled between the light source driving circuit and the light source to monitor the driving current of the light source to output a monitoring signal. The control circuit controls the light source driving circuit to adjust the driving current provided to the light source according to the monitoring signal. In this way, by monitoring the driving current of the light source through the current monitoring circuit located on the current path of the driving current, an accurate monitoring signal may be obtained, so that the control circuit may control the light source driving circuit to accurately correct the driving current based on the monitoring signal to provide a correct driving current to drive the light source and to prevent the image display quality of the projection device from deteriorating.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic diagram of a conventional laser diode driver chip.

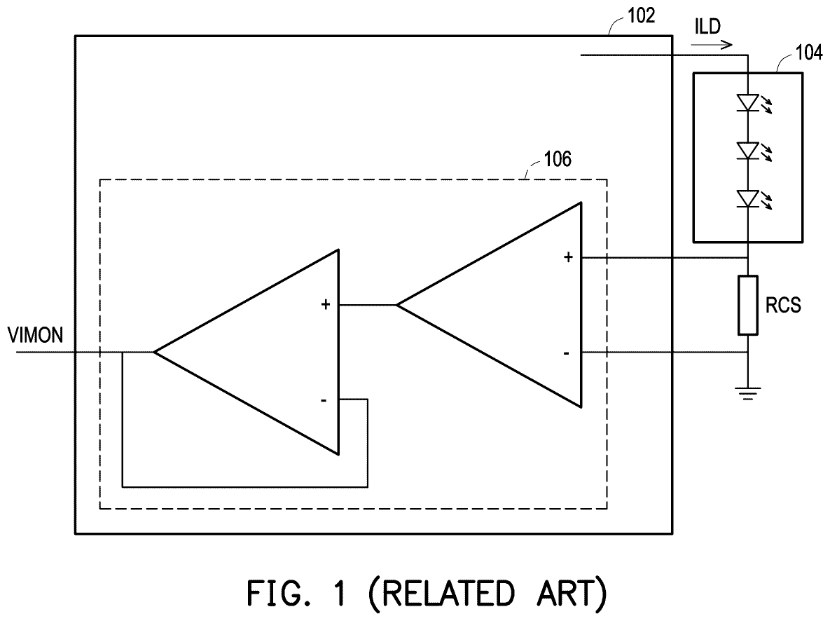

FIG. 2 is a schematic diagram of a light source current adjustment device for a projection device according to an embodiment of the present disclosure.

FIG. 3 is a schematic diagram of a lookup table for a light source current adjustment device and a light source according to an embodiment of the present disclosure.

FIG. 4 is a waveform diagram of a current value corresponding to a monitoring signal and a preset driving current according to an embodiment of the present disclosure.

FIG. 5 is a schematic diagram of a light source current adjustment device for a projection device according to another embodiment of the present disclosure.

FIG. 6 is a flow chart of a light source current adjustment method for a projection device according to an embodiment of the present disclosure.

FIG. 7 is a flow chart of a light source current adjustment method for a projection device according to another embodiment of the present disclosure.

### DESCRIPTION OF THE EMBODIMENTS

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

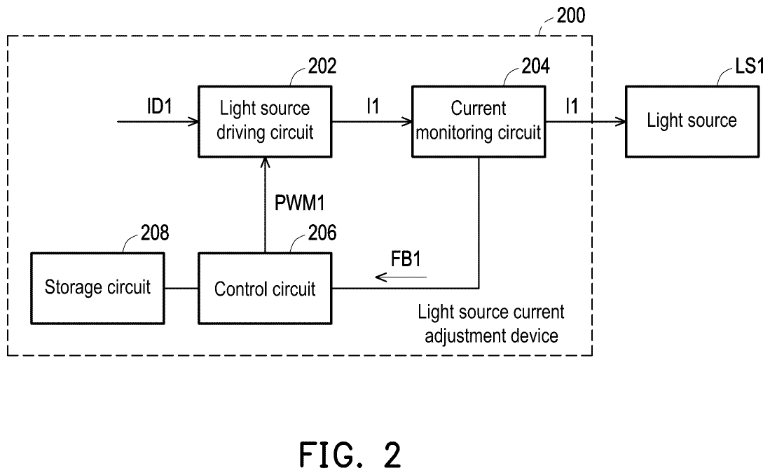

FIG. 2 is a schematic diagram of a light source current adjustment device of a projection device according to an embodiment of the present disclosure. Please refer to FIG. 2. The light source current adjustment device 200 may include a light source driving circuit 202, a current monitoring circuit 204, a control circuit 206 and a storage circuit 208. The control circuit 206 is coupled to the light source driving circuit 202, the current monitoring circuit 204 and the storage circuit 208. The current monitoring circuit 204 is further coupled to the light source driving circuit 202 and the light source LS1 of the projection device. In the embodiment, the projection device is, for example, configured to receive image data and project an image beam according to the image data to form a projected image on the projection surface. The projection device includes a light source module (including light source LS1), a light valve and a projection lens. For example, the light source LS1 is suitable for providing a light beam, and the light source module emits an illumination beam, wherein the illumination beam may include at least part of the light beam. The light valve converts the illumination beam into an image beam based on the image data, and the projection lens projects the image beam onto the projection plane to form the projected image. The light valve is, for example, a Digital Micro-mirror Device (DMD), a Liquid Crystal on Silicon Panel (LCOS Panel), or a Liquid Crystal Display Panel (LCD panel). The projection lens includes, for example, a lens structure composed of one or more optical lenses with refractive power, but the disclosure is not limited thereto.

Please continue to refer to FIG. 2. The light source driving circuit 202 may generate the driving current I1 according to the direct current ID1. The current monitoring circuit 204 is coupled between the light source driving circuit 202 and the light source LS1. That is, the current monitoring circuit 204 is disposed on the current path I1 of the driving current. The current monitoring circuit 204 is configured to monitor the driving current I1 to output the monitoring signal FB1. The current monitoring circuit 204 may be, for example, an isolation current sensor. The control circuit 206 may receive the monitoring signal FB1 from the current monitoring circuit 204, and control the light source driving circuit 202 to adjust the driving current I1 according to the monitoring signal FB1. The current monitoring circuit 204 may provide an adjusted driving current I1 from the light source driving circuit 202 to the light source LS1.

For example, when the current value corresponding to the monitoring signal FB1 is less than the preset current value of the light source LS1 of the projection device in the projection mode, the control circuit 206 controls the light source driving circuit 202 to increase the driving current I1, and the light source driving circuit 202 adjusts the driving current I1 to be equal to the preset current value. When the current value corresponding to the monitoring signal FB1 is greater than the preset current value of the light source LS1 of the projection device in the projection mode, the control circuit 206 controls the light source driving circuit 202 to reduce the driving current I1, and the light source driving circuit 202 adjusts the driving current I1 to be equal to the preset current value. In this embodiment, the projection device has multiple projection modes, such as bright/theater/game/sports/standard/vivid modes, and these projection modes respectively correspond to the same and/or different preset current values. The preset current value is pre-stored in each projection device. The preset current value is, for example, the current value at the same standard and serves as reference for every projection device for allowing every projection device to maintain the optimal brightness and color, or may be a preset current average value in some embodiment. The preset current average value is, for example, an average value (or root mean square value) of the driving current value of the light source during a period when the light source module provides a light beam of a certain color (such as a red light beam). However, the disclosure is not limited thereto.

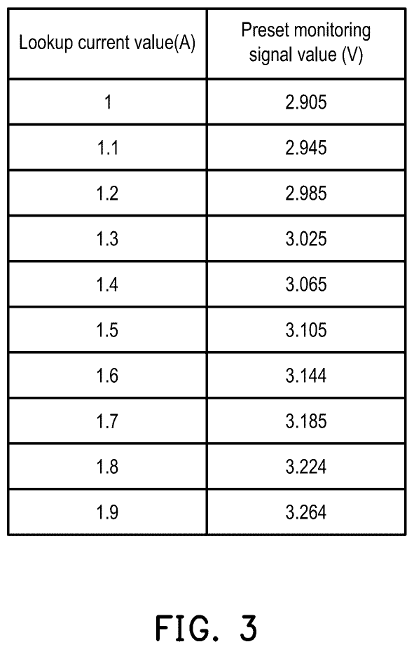

Furthermore, the storage circuit 208 may be configured to store the lookup table. The storage circuit 208 is, for example, any type of random access memory (RAM), read-only memory (ROM), flash memory or other similar devices or a combination of the devices. The lookup table stored in the storage circuit 208 may be, for example, as shown in FIG. 3, including a plurality of preset monitoring signal values (for example, voltage values) and a plurality of lookup current values corresponding thereto. The control circuit 206 may find the lookup current value corresponding to the monitoring signal FB1 according to the lookup table and use the lookup current value as the current value corresponding to the monitoring signal FB1, compare the preset current value corresponding to the projection device in projection mode with the lookup current value, and control the light source driving circuit 202 to adjust the driving current I1 according to the comparison result. For example, when the monitoring signal FB1 sensed by the current monitoring circuit 204 at a time point is voltage value 3.025V, the control circuit 206 may find the lookup current value corresponding to the voltage value 3.025V through the lookup table in the storage circuit 208 as 1.3 A, and use the lookup current value as the current value corresponding to the monitoring signal FB1 at this time point. When the projection mode of the projection device is theater mode, the preset current value in the theater mode is 1.4 A. After the control circuit 206 compares the preset current value corresponding to the theater mode with the lookup current value, since the preset current value (1.4 A) is greater than the lookup current value (1.3 A), the control circuit 206 may control the light source driving circuit 202 to increase the driving current I1 based on the comparison result until the lookup current value found by the control circuit 206 according to the monitoring signal FB1 at another point in time is equal to the preset current value. In some embodiments, the control circuit 206 may also set a preset range for controlling the light source driving circuit 202 to adjust the driving current I1. When the difference between the preset current value and the lookup current value is not equal to 0 (that is, the preset current value is greater than or less than the lookup current value), if the difference between the preset current value and the lookup current value falls within the preset range, the control circuit 206 does not need to control the light source driving circuit 202 to adjust the driving current I1, but controls the light source driving circuit 202 to adjust the driving current I1 only when the difference between the preset current value and the lookup current value exceeds the preset range, thereby preventing the driving current I1 from being adjusted frequently.

In this embodiment, the control circuit 206 may adjust a duty ratio of the pulse width modulation signal PWM1 provided to the light source driving circuit 202, so that the light source driving circuit 202 adjusts the driving current I1 according to an adjusted duty ratio of the pulse width modulation signal PWM1. For example, when it is necessary to increase or decrease the driving current I1, the duty ratio of the pulse width modulation signal PWM1 may be increased or decreased to correspondingly increase or decrease the driving current I1. In other embodiments, the storage circuit 208 may also store the adjusted duty ratio of the pulse width modulation signal PWM1 as the preset duty ratio, so that the next time when the projection device is turned on, the control circuit 206 may control the light source driving circuit 206 to provide the driving current I1 according to the adjusted duty ratio of the pulse width modulation signal PWM1 stored in the storage circuit 208.

The control circuit 206 may include, for example, a micro control unit (MCU) chip and a digital light processing (DLP) chip, wherein the MCU chip is configured to read the monitoring signal FB1 output by the current monitoring circuit 204, finds the lookup current value corresponding to the monitoring signal FB1 according to the lookup table and uses the lookup current value as the current value corresponding to the monitoring signal FB1. The DLP chip determines whether to use the pulse width modulation signal PWM1 to control the light source driving circuit 202 to adjust the driving current I1 based on the current value corresponding to the monitoring signal FB1. In other embodiments, the MCU chip may also be, for example, replaced by an analog to digital converter (ADC) chip. In some embodiments, if the DLP chip has the function of reading analog signals, for example, the function of reading the monitoring signal FB1 output by the current monitoring circuit 204, it is possible to omit the configuration of the MCU chip or the ADC chip. Therefore, the DLP chip may be directly configured to read the monitoring signal FB1 output by the current monitoring circuit 204, find the lookup current value corresponding to the monitoring signal FB1 according to the lookup table and use the lookup current value as the current value corresponding to the monitoring signal FB1, and determine whether to use the pulse width modulation signal PWM1 to control the light source driving circuit 202 to adjust the driving current I1 according to the current value corresponding to the monitoring signal FB1. It is worth noting that in other embodiments, the light source current adjustment device 200 may also integrate the storage circuit 208 into the control circuit 206, that is, the control circuit 206 may store the lookup table without providing the storage circuit 208.

The entire operation process of the light source current adjustment device of the projection device will be further described below. Please continue to refer to FIG. 2. After the projection device is turned on, the light source current adjustment device 200 starts to operate, and the current monitoring circuit 204 transmits the detected monitoring signal FB1 to the control circuit 206. Since each projection device has passive components configured for the light source LS1, such as resistors/capacitors/inductors, the impedance of the passive components will be different, and each projection device has tolerances for the passive components configured for the light source LS1. For example, when the impedance of these passive components is less than the normal value, it means that the current value corresponding to the present monitoring signal FB1 will be greater than the preset current value of the present projection mode. For example, the current value corresponding to the present monitoring signal FB1 is 1.5 A, which is greater than the preset current value 1.4 A of the present projection mode (such as the theater mode mentioned above). The control circuit 206 reduces the duty ratio of the output pulse width modulation signal PWM1 according to the comparison result, so that the light source driving circuit 206 reduces the driving current I1 to the preset current value of the projection mode according to the adjusted duty ratio of the pulse width modulation signal PWM1, for example, reduces the driving current I1 to the preset current value 1.4 A of the theater mode, then the control circuit 206 controls the storage circuit 208 to record the present duty ratio of the pulse width modulation signal PWM1 as a parameter for subsequent startup operation of the projection device. When the impedance of these passive components is close to the normal value, the current value corresponding to the present monitoring signal FB1 will be substantially equal to the preset current value of the present projection mode. For example, the current value 1.4 A corresponding to the present monitoring signal FB1 is equal to the preset current value 1.4 A of the present projection mode (such as the theater mode mentioned above), and the control circuit 206 does not adjust the duty ratio of the output pulse width modulation signal PWM1 based on the comparison result. When the impedance of these passive components is greater than the normal value, the current value corresponding to the present monitoring signal FB1 will be less than the preset current value of the present projection mode. For example, the current value 1.3 A corresponding to the present monitoring signal FB1 is less than the preset current value 1.4 A in the present projection mode (such as the theater mode mentioned above), and the control circuit 206 increases the duty ratio of the output pulse width modulation signal PWM1 based on the comparison result. In this way, the light source driving circuit 206 increases the driving current I1 to the preset current value of the projection mode according to the adjusted duty ratio of the pulse width modulation signal PWM1, for example, increases the driving current I1 to the preset current value 1.4 A in the theater mode, and the control circuit 206 controls the storage circuit 208 to record the present duty ratio of the pulse width modulation signal PWM1 as a parameter used for subsequent startup operation of the projection device.

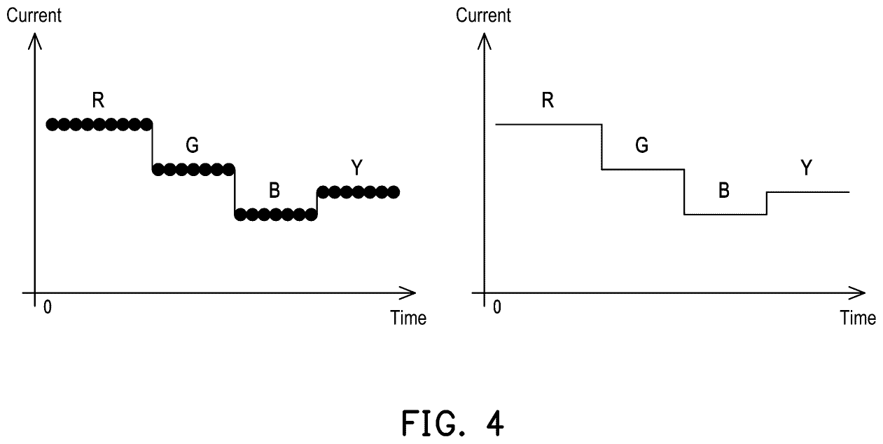

In this way, by sensing the driving current I1 through the current monitoring circuit 204 disposed on the current path of the driving current I1, it is possible to prevent the accuracy of the sensing result from being affected by the resistance as in the conventional technology, and an accurate monitoring signal FB1 may be obtained, which enables the control circuit 206 to control the light source driving circuit 202 to accurately correct the driving current I1 according to the accurate monitoring signal FB1 to provide a correct driving current I1 to drive the light source LS1, so as to avoid degradation of the image display quality of the projection device. For example, the left picture in FIG. 4 is a waveform diagram of the current value of the driving current I1 corresponding to the monitoring signal at different time points, and the right picture in FIG. 4 is a waveform diagram of the preset current value of the driving current, as shown in FIG. 4, the control circuit 206 controls the light source driving circuit 202 in real time to accurately adjust the driving current I1 according to the monitoring signal FB1. When the light source module provides illumination beams of different colors at different timings (such as the red light R timing, green light G timing, blue light B timing, and yellow light Y timing shown in FIG. 4), the current values of the driving current I1 configured to drive the light source LS1 in the timing corresponding to various color lights are consistent with the preset current values corresponding to the illumination beams of various colors. For example, after comparing the waveforms, if the driving current I1 monitored during the red light R timing in the left picture in FIG. 4 is greater than the preset current value in the red light R timing in the right picture in FIG. 4, the control circuit 206 will reduce the duty ratio of the pulse width modulation signal PWM1 of the light source module in the red light R timing, thereby making the light source driving circuit 206 to reduce the driving current I1 provided to the light source LS1 in the red light R timing. If the driving current I1 monitored during the red light R timing in the left picture of FIG. 4 is less than the preset current value of the red light R timing in the right picture of FIG. 4, the control circuit 206 will increase the duty ratio of the pulse width modulation signal PWM1 of the light source module in the red light R timing, thereby making the light source driving circuit 206 to increase the driving current I1 provided to the light source LS1 in the red light R timing. When the driving current I1 is adjusted to the preset current value, the control circuit 206 controls the storage circuit 208 to record the present duty ratio of the pulse width modulation signal PWM1 as a parameter for subsequent startup operation of the projection device. In addition, the operation of the control circuit 206 in the green light G timing, the blue light B timing, and the yellow light Y timing is the same as that in the red light R timing, so no further repetition is provided.

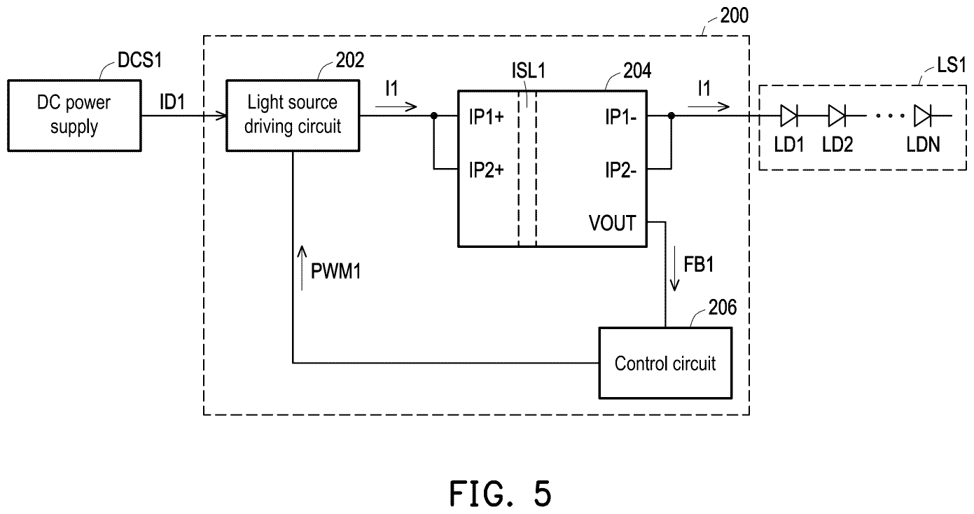

Furthermore, the current monitoring circuit 204 described in the embodiment of FIG. 2 may be implemented, for example, with a current detection chip (model MT9221), as shown in FIG. 5, which has input terminals IP1+ and IP2+, output terminals IP1− and IP2− and VOUT. In addition, in the embodiment of FIG. 5, the light source driving circuit 202 receives the direct current ID1 from the DC power supply DCS1, and generates the driving current I1 according to the direct current ID1. The light source LS1 may be implemented with multiple laser diodes (LD) LD1˜LDN connected in series, but the disclosure is not limited thereto. In other embodiments, the light source LS1 may also be applied to models of projection devices with light emitting diodes (LED). In the embodiment, the current monitoring circuit 204 has an isolation layer ISL1 for detecting currents. The current monitoring circuit 204 may receive the driving current I1 by the input terminals IP1+ and IP2+ and output the driving current I1 to the light source LS1 by the output terminals IP1− and IP2−. Additionally, the current monitoring circuit 204 disposed on the current path of the driving current I1 may adopt the isolation layer ISL1 to perform isolation current sensing, thereby avoiding the problem of low accuracy caused by using a resistor to monitor the driving current as in the conventional technology.

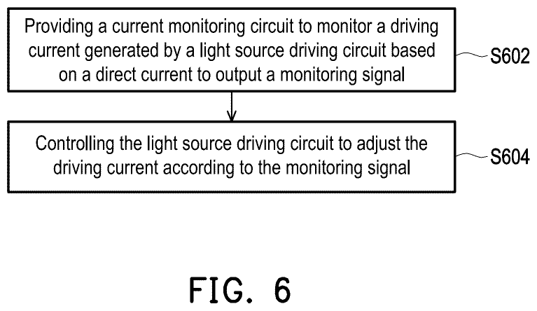

FIG. 6 is a flow chart of a light source current adjustment method for a projection device according to an embodiment of the present disclosure. As can be seen from the above embodiments, the light source current adjustment method for the projection device may include the following steps. First, a current monitoring circuit is provided to monitor the driving current generated by the light source driving circuit based on the direct current to output a monitoring signal (step S602), wherein the current monitoring circuit is configured on the current path through which the driving current flows between the light source driving circuit and the light source, the current monitoring circuit may be, for example, an isolation current sensor, and the driving current is configured to drive the light source of the projection device. Next, the light source driving circuit is controlled to adjust the driving current according to the monitoring signal (step S604). The current monitoring circuit may provide an adjusted driving current from the light source driving circuit to the light source to drive the light source.

In this way, by sensing the driving current through the current monitoring circuit disposed on the current path of the driving current, it is possible to prevent the accuracy of the sensing results from being affected by the resistance as in the conventional technology, and an accurate monitoring signal may be obtained, thereby accurately correcting the driving current based on the monitoring signal. The correct driving current is provided to drive the light source to avoid deterioration in the display quality of the projection device.

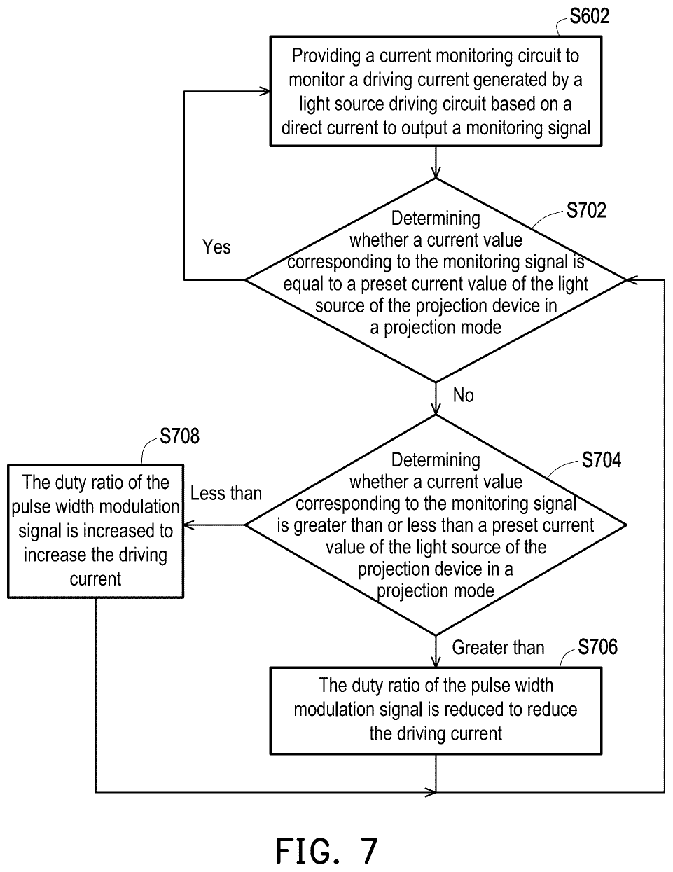

Furthermore, the method of controlling the light source driving circuit to adjust the driving current according to the monitoring signal may be shown in steps S702 to S708 in FIG. 7. After step S602, it is first determined whether the current value corresponding to the monitoring signal is equal to the preset current value of the light source of the projection device in the projection mode (step S702); if the result is positive, then return to step S602; if the result is negative, then it is then determined whether the current value corresponding to the monitoring signal is greater than or less than the preset current value of the light source of the projection device in the projection mode (step S704). If the current value corresponding to the monitoring signal is greater than the preset current value of the light source of the projection device in the projection mode, the light source driving circuit is controlled to reduce the driving current, for example, the duty ratio of the pulse width modulation signal provided to the light source driving circuit is reduced to reduce the driving current (step S706). If the current value corresponding to the monitoring signal is less than the preset current value of the light source of the projection device in the projection mode, the light source driving circuit is controlled to increase the driving current, for example, the duty ratio of the pulse width modulation signal provided to the light source driving circuit is increased to increase the driving current (step S708). The method of comparing the current value of the monitoring signal with the preset current value of the light source of the projection device in the projection mode may be performed by using a lookup table. For example, the lookup table may be read first. The lookup table may include multiple preset monitoring signal values and multiple lookup current values corresponding thereto, and then the lookup current value corresponding to the monitoring signal is found according to the lookup table and used as the current value corresponding to the monitoring signal. Then the preset current value corresponding to the projection device in the projection mode is compared with the lookup current value, and the driving current may be adjusted based on the comparison result.

In some embodiments, an adjusted duty ratio of the pulse width modulation signal may be set to a preset duty ratio, so that the next time when the projection device is turned on, the light source driving circuit is controlled based on the adjusted duty ratio of the pulse width modulation signal to provide the driving current. Moreover, in other embodiments, the light source driving circuit may be controlled to adjust the driving current only when the difference between the current value corresponding to the monitoring signal and the preset current value corresponding to the projection device in the projection mode exceeds the preset range, so as to avoid frequent adjustment of the driving current.

In summary, the current monitoring circuit of the present disclosure is disposed between the light source driving circuit and the light source to monitor the driving current of the light source to output a monitoring signal. The control circuit controls the light source driving circuit to adjust the driving current provided to the light source based on the monitoring signal. In this way, by monitoring the driving current of the light source through the current monitoring circuit located on the current path of the driving current, an accurate monitoring signal may be obtained, so that the control circuit may control the light source driving circuit to accurately correct the driving current based on the monitoring signal to provide a correct driving current to drive the light source, so as to avoid deterioration in the display quality of the projection device.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A light source current adjustment device of a projection device, coupled to a light source of the projection device, wherein the light source current adjustment device comprises a light source driving circuit, a current monitoring circuit and a control circuit, wherein
the light source driving circuit generates a driving current based on a direct current;
the current monitoring circuit is coupled between the light source driving circuit and the light source to monitor the driving current and output a monitoring signal; and
the control circuit is coupled to the light source driving circuit and the current monitoring circuit, receives the monitoring signal from the current monitoring circuit, and controls the light source driving circuit to adjust the driving current according to the monitoring signal, the current monitoring circuit provides an adjusted driving current from the light source driving circuit to the light source.

2. The light source current adjustment device according to claim 1, wherein when a current value corresponding to the monitoring signal is less than a preset current value of the light source of the projection device in a projection mode, the control circuit controls the light source driving circuit to increase the driving current, and when the current value corresponding to the monitoring signal is greater than the preset current value, the control circuit controls the light source driving circuit to reduce the driving current.

3. The light source current adjustment device according to claim 2, wherein the control circuit adjusts a duty ratio of a pulse width modulation signal provided to the light source driving circuit, so that the light source driving circuit adjusts the driving current according to an adjusted duty ratio of the pulse width modulation signal.

4. The light source current adjustment device according to claim 3, wherein the control circuit further stores the adjusted duty ratio of the pulse width modulation signal as a preset duty ratio.

5. The light source current adjustment device according to claim 1, wherein the control circuit controls the light source driving circuit to adjust the driving current when a difference between a current value corresponding to the monitoring signal and a preset current value corresponding to the projection device in a projection mode exceeds a preset range.

6. The light source current adjustment device according to claim 2, wherein the control circuit comprises a lookup table, the lookup table comprises a plurality of preset monitoring signal values and a plurality of lookup current values corresponding thereto, the control circuit finds a lookup current value corresponding to the monitoring signal according to the lookup table and uses the lookup current value as the current value corresponding to the monitoring signal, compares the preset current value corresponding to the projection device in the projection mode with the lookup current value, and controls the light source driving circuit to adjust the driving current according to a comparison result.

7. The light source current adjustment device according to claim 1, wherein the current monitoring circuit is disposed on a current path through which the driving current flows between the light source driving circuit and the light source, and the current monitoring circuit is an isolation current sensor.

8. A light source current adjustment method for a projection device, comprising:
providing a current monitoring circuit to monitor a driving current generated by a light source driving circuit based on a direct current to output a monitoring signal, wherein the driving current is configured to drive a light source of the projection device; and
controlling the light source driving circuit to adjust the driving current according to the monitoring signal, wherein the current monitoring circuit provides an adjusted driving current from the light source driving circuit to the light source.

9. The light source current adjustment method for the projection device according to claim 8, comprising:
when a current value corresponding to the monitoring signal is less than a preset current value of the light source of the projection device in a projection mode, controlling the light source driving circuit to increase the driving current; and
when the current value corresponding to the monitoring signal is greater than the preset current value, controlling the light source driving circuit to reduce the driving current.

10. The light source current adjustment method for the projection device according to claim 9, comprising:
adjusting a duty ratio of a pulse width modulation signal provided to the light source driving circuit, so that the light source driving circuit adjusts the driving current according to an adjusted duty ratio of the pulse width modulation signal.

11. The light source current adjustment method for the projection device according to claim 10, comprising:
setting the adjusted duty ratio of the pulse width modulation signal as a preset duty ratio.

12. The light source current adjustment method for the projection device according to claim 8, comprising:
controlling the light source driving circuit to adjust the driving current when a difference between a current value corresponding to the monitoring signal and a preset current value corresponding to the projection device in a projection mode exceeds a preset range.

13. The light source current adjustment method for the projection device according to claim 9, comprising:
reading a lookup table, wherein the lookup table comprises a plurality of preset monitoring signal values and a plurality of lookup current values corresponding thereto; and
finding a lookup current value corresponding to the monitoring signal according to the lookup table and using the lookup current value as the current value corresponding to the monitoring signal, comparing the preset current value corresponding to the projection device in the projection mode with the lookup current value, and controlling the light source driving circuit to adjust the driving current according to a comparison result.

14. The light source current adjustment method for the projection device according to claim 8, wherein the current monitoring circuit is disposed on a current path through which the driving current flows between the light source driving circuit and the light source, and the current monitoring circuit is an isolation current sensor.
